(19) United States
(12) Patent Application Publication
(10) Pub. No.: US 2026/0281820 A1
(43) Pub. Date: Sep. 17, 2026

(54) SYSTEMS AND METHODS FOR NEGOTIATING TIME SENSITIVE COMMUNICATION INFORMATION

(71) Applicant: Telefonaktiebolaget LM Ericsson (PUBL), Stockholm (SE)

(72) Inventors: Nianshan SHI, JÄRFÄLLA (SE); Jonas FRÖBERG OLSSON, LJUNGSBRO (SE)

(21) Appl. No.: 19/471,628

(22) PCT Filed: Apr. 4, 2024
(86) PCT No.: PCT/SE2024/050307

§ 371 Date: Oct. 1, 2025

Related U.S. Application Data
(60) Provisional application No. 63/494,070, filed on Apr. 4, 2023.

(51) Int. Cl. H04W 28/18; H04W 28/02

(52) U.S. Cl. CPC H04W 28/18; H04W 28/0268

(57) ABSTRACT

A method (1000) by a user equipment, UE (112), for negotiating parameters associated with a time sensitive communication, TSC, is provided. The method includes receiving (1002), from a Radio Access Network, RAN, node (110), a first set of TSC assistance information, TSCAI, parameters and an indication to provide feedback. The UE transmits (1004), to the RAN node, feedback associated with a used set of TSCAI parameters and/or a second set of TSCAI parameters.

### TECHNICAL FIELD

The present disclosure relates, in general, to wireless communications and, more particularly, systems and methods for negotiating Time Sensitive Communication (TSC) information.

### BACKGROUND

In the 5^{TH} Generation (5G) quality of service (QoS) framework, a QoS flow is established in the 5G system and can be mapped to a data radio bearer (DRB). The QoS flow is associated with QoS parameters and/or a 5Q QoS Indicator (5QI) such as, for example, a packet delay budget (PDB). The 5G radio access network (RAN) scheduling packets of this QoS flow (mapped to a DRB in 5G RAN) delivers packets within this PDB.

Another metric, related to PDB, is called survival time and may be relevant in, for example, the industrial automation communication context. According to 3GPP TS 22.261 v18.4.0 and 3GPP TS 22.104 v18.2.0, survival time is defined as the time that an application consuming a communication service may continue without an anticipated message. The message is anticipated at the end of the PDB, and the survival time is the maximum additional time that a message is expected after PDB.

For time sensitive communication (TSC) traffic types (typical in industrial automation communication, for example), 3GPP TS 23.501 v17.2.0 specifies TSC assistance information (TSCAI) signaling, with which further information on the QoS flow traffic can be provided from 5G core network to RAN. The knowledge of TSC traffic pattern is useful for 5G Access Network (5G-AN) to allow it to more efficiently schedule periodic, deterministic traffic flows either via Configured Grants, Semi-Persistent Scheduling, or Dynamic Grants. A Survival Time may be provided either in terms of maximum number of messages (message is equivalent to a burst) or in terms of time units. Single burst is expected within a single time period referred to as the periodicity. Table 1 corresponds to Table 5.27.2-1 from TS 23.501 v17.2.0 and provides TSCAI:

TABLE 1

| Assistance | |
|---|---|
| Information | Description |
| Flow Direction | The direction of the TSC flow (uplink or downlink). |
| Periodicity | It refers to the time period between start of two bursts. |
| Burst Arrival time | The latest possible time when the first packet of the data burst arrives |
| (Optional) | at either the ingress of the RAN (downlink flow direction) or egress |
| | interface of the UE (uplink flow direction). |
| Survival Time | Survival Time, as defined in TS 22.261, is synonymous with the time |
| (Optional) | period an application can survive without any burst. |

There currently exist certain challenges, however. For example, one key problem for Next Generation-RAN (NG-RAN) is to serve all User Equipment (UE) such that their QoS requirements are fulfilled. The ability to fulfill this task depends heavily on how packets or packet bursts arrive relative to each other. If packet arrival lines up in time for all UEs, the NG-RAN needs to serve all these packets within a short period of time, which may be impossible. However, if packet arrivals are spread out in time, fewer packets need to be served at the same time, which may make it easier for NG-RAN to uphold the QoS requirements.

The key question is then how to trigger the resource allocation spreading when a time critical service is requested. Currently, there are no good solutions. For example, in the current specification, if the gNodeB (gNB) cannot meet the QoS and other requirements for the service, it will reject the service. Otherwise, if the gNB can meet the QoS and other requirements for the service, the gNB will setup according to the request TSCAI and handle the congestion such as, for example, by dropping the package and/or dropping the connection.

### SUMMARY

Certain aspects of the disclosure and their embodiments may provide solutions to these or other challenges. For example, according to certain embodiments, methods and systems are provided enabling a network node such as a gNB, for example, to send information such as an offset value to the Core Network (CN) when the TSCAI needs to be adjusted. Additionally or alternatively, methods and systems enable the CN to send a list of alternative TSCAI so that the gNB may choose the best one and plan for future potential modification.

According to certain embodiments, a method by a UE for negotiating parameters associated with a TSC includes receiving, from a RAN node, a first set of TSCAI parameters and an indication to provide feedback. The UE transmits, to the RAN node, feedback associated with a used set of TSCAI parameters and/or a second set of TSCAI parameters.

According to certain embodiments, a UE for negotiating parameters associated with a TSC is configured to receive, from a RAN node, a first set of TSCAI parameters and an indication to provide feedback. The UE is configured to transmit, to the RAN node, feedback associated with a used set of TSCAI parameters and/or a second set of TSCAI parameters.

According to certain embodiments, a method by a CN node for negotiating parameters associated with a TSC includes transmitting, to a RAN node, a first set of TSCAI parameters. The CN node receives, from the RAN node, feedback associated with a used set of TSCAI parameters and/or a second set of TSCAI parameters.

According to certain embodiments, a method by a RAN node for negotiating parameters associated with a TSC includes receiving, from a CN node, a first set of TSCAI parameters. The RAN node transmits, to the CN, feedback associated with a used set of TSCAI parameters and/or a second set of TSCAI parameters.

According to certain embodiments, a RAN node for negotiating parameters associated with a TSC is configured to receive, from a CN node, a first set of TSCAI parameters. The RAN node is configured to transmit, to the CN, feedback associated with a used set of TSCAI parameters and/or a second set of TSCAI parameters.

Certain embodiments may provide one or more of the following technical advantages. For example, certain embodiments may provide a technical advantage of enabling more efficient scheduling and use of radio resources when serving a time critical service. As another example, certain embodiments may provide a technical advantage of, instead of rejecting the service due to congestion, the connection can be accepted when the data transmission, e.g. burst arrivals are adjusted.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example communication system, according to certain embodiments;

FIG. 2 illustrates an example UE, according to certain embodiments;

FIG. 3 illustrates an example network node, according to certain embodiments;

FIG. 4 illustrates a block diagram of a host, according to certain embodiments;

FIG. 5 illustrates a virtualization environment in which functions implemented by some embodiments may be virtualized, according to certain embodiments;

FIG. 6 illustrates a host communicating via a network node with a UE over a partially wireless connection, according to certain embodiments;

FIG. 7 illustrates an example method by a UE for negotiating parameters associated with a TSC, according to certain embodiments;

FIG. 8 illustrates an example method by a network node for negotiating parameters associated with a TSC, according to certain embodiments;

FIG. 9 illustrates an example method by a network node for negotiating parameters associated with a TSC, according to certain embodiments;

FIG. 10 illustrates another example method by a UE for negotiating parameters associated with a TSC, according to certain embodiments;

FIG. 11 illustrates another example method by a CN node for negotiating parameters associated with a TSC, according to certain embodiments; and

FIG. 12 illustrates another example method by a RAN node for negotiating parameters associated with a TSC, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (Enb), gNodeB (Gnb), Master Enb (MeNB), Secondary Enb (SeNB), integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a Gnb), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g., Mobile Switching Center (MSC), Mobility Management Entity (MME), etc.), Operations & Maintenance (O&M), Operations Support System (OSS), Self Organizing Network (SON), positioning node (e.g., E-SMLC), etc.

Another example of a node is UE, which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology such as “radio network node” or simply “network node (NW node)” or “Radio Access Network” is used. These terms may include any kind of network node which may include base station, radio base station, base transceiver station, base station controller, network controller, evolved Node B (eNB), Node B, gNodeB (gNB), relay node, access point, radio access point, RRU RRH, Central Unit (e.g., in a gNB), Distributed Unit (e.g., in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

The term signal or radio signal used herein can be any physical signal or physical channel. Examples of DL physical signals are reference signal (RS) such as Primary Synchronization Signal (PSS), Secondary Synchronization Signal (SSS), Channel State Information-Reference Signal (CSI-RS), Demodulation Reference Signal (DMRS) signals in Synchronization Signal/Physical Broadcast Channel block (SSB), discovery reference signal (DRS), Cell-Specific Reference Signal (CRS), Positioning Reference Signal (PRS), etc. RS may be periodic such as, for example, RS occasion carrying one or more RSs may occur with certain periodicity such as, for example, 20 ms, 40 ms, etc. The RS may also be aperiodic. Each SSB carries New Radio-PSS (NR-PSS), New Radio-SSS (NR-SSS), and New Radio-Physical Broadcast Channel (NR-PBCH) in four successive symbols. One or multiple SSBs are transmit in one SSB burst that is repeated with certain periodicity such as, for example, 5 ms, 10 ms, 20 ms, 40 ms, 80 ms, and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with regard to reference time (e.g., serving cell's System Frame Number (SFN)), etc. Therefore, SMTC occasion may also occur with certain periodicity such as, for example, 5 ms, 10 ms, 20 ms, 40 ms, 80 ms, and 160 ms. Examples of uplink (UL) physical signals are reference signal such as Sounding Reference Signal (SRS), DMRS, etc. The term physical channel refers to any channel carrying higher layer information such as data, control, etc. Examples of physical channels are PBCH, Narrowband PBCH (NPBCH), Physical Downlink Control Channel (PDCCH), Physical Downlink Shared Channel (PDSCH), Physical Uplink Shared Channel (PUSCH), Physical Uplink Control Channel (PUCCH), shortened PUCCH (sPUCCH), shortened PDSCH (sPDSCH), shortened PUCCH (sPUCCH), shortened PUSCH (sPUSCH), MTC PDCCH (MPDCCH), Narrowband PDCCH (NPDCCH), Narrowband PDSCH (NPDSCH), Enhanced PDCCH (E-PDCCH), Narrowband PUSCH (NPUSCH), etc.

The term time resource used herein may correspond to any type of physical resource or radio resource expressed in terms of length of time. Examples of time resources are: symbol, time slot, subframe, radio frame, Transmission Time Interval (TTI), interleaving time, slot, sub-slot, mini-slot, SFN cycle, hyper-SFN (H-SFN) cycle, etc.

For example, according to certain embodiments, methods and systems are provided enabling a network node such as a gNB, for example, to send information such as an offset value to the CN when the TSCAI needs to be adjusted. Additionally or alternatively, methods and systems enable the CN to send a list of alternative TSCAI so that the gNB may choose the best one and plan for future potential modification.

According to certain embodiments, for periodic traffic, the network node such as the gNB, for example, is aware of the packet arrival at either the UE or the gNB (i.e., by using TSCAI parameters). The gNB is able to control to split schedule for different UEs.

According to certain embodiments, during the establishment of the time critical service, the network node such as a gNB, for example, indicates to the CN the appropriate time offset for the UE data arrival suggested via the CN to the application to shift the Burst Arrival Time for the payload with some offset, so that the gNB could handle more UEs with better quality when the transmission/reception are split.

According to certain embodiments, the CN indicates the alternative time critical requirements during the setting of the QoS and allows the network node to pick the best set. The application will then use the “best” set of the parameters in the communication.

According to certain embodiments, the network provides the TSCAI to UE. UE may provide its adjustment or preferred TSCAI information, in particular embodiments.

### CN Embodiments

According to certain embodiments, during QoS flow setup/modification, the CN provides to RAN an Alternative Set of TSCAI parameters. For example, Table 2 illustrates an example information element (IE) that may be incorporated into 3GPP TS 38.413, Chapter 9.3.1.130 for including alternative TSC information providing the traffic characteristics of TSC QoS flows.

TABLE 2

| | | | | |
|---|---|---|---|---|
| IE/Group | | | IE type and | Semantics |
| Name | Presence | Range | reference | description |

| | | | |
|---|---|---|---|
| TSC Assistance | O | | TSC |
| Information | | | Assistance |
| Downlink | | | Information |
| | | | 9.3.1.131 |
| TSC Assistance | O | | TSC |
| Information | | | Assistance |
| Uplink | | | Information |
| | | | 9.3.1.131 |
| Alternative | | 0 . . . 1 | |
| TSCAI List | | | |
| >Alternative | | <1 . . . MaxNoOfAlternativeTSCAI> | |
| TSCAI List | | | |
| Items | | | |
| >>TSC | O | | TSC |
| Assistance | | | Assistance |
| Information | | | Information |
| Downlink | | | 9.3.1.131 |
| >>TSC | O | | TSC |
| Assistance | | | Assistance |
| Information | | | Information |
| Uplink | | | 9.3.1.131 |

According to certain embodiments, including an Alternative Set of TSCAI parameters may have two purposes. One purpose is to allow the network node such as the gNB that isn't able to use the original TSCAI to be able to choose one of the set of TSCAI that it can use and feedback to CN the result. The communication is setup with the chosen TSCAI. Another purpose is to enable the network node such as the gNB to be informed with the future potential modification such that it can prepare a resource plan accordingly.

In another particular embodiment, the CN takes the feedback from the network node such as the gNB, communicates it to the service application level when needed, and/or makes an adjustment. In a particular embodiment, the gNB may provide feedback including the part from gNB and the part from UE.

In another particular embodiment, the CN receives the TSC parameters that the network node can use. The TSC parameters received by the CN may or may not be in the CN Alternative list, in certain particular embodiments.

In another particular embodiment, the CN receives the offset of the TSC parameters that the network node such as the gNB proposes.

In another particular embodiment, the CN may indicate to the network node such as the gNB that the negotiation is not allowed.

In another particular embodiment, the CN indicates to the network node such as the gNB a set or range of parameter values from which the gNB may choose. For example, the CN may provide the gNB with a first Burst Arrival time and a range parameter, W, and the gNB may choose a second Burst Arrival time such as, for example:

First Burst Arrival time−W≤Second Burst Arrival time≤First Burst Arrival time+W

### NG-RAN Node Embodiments

According to certain embodiments, upon reception of the TSC parameters during the QoS flow setup/modification, the network node such as the gNB or another network node checks radio resources and the current load situation and determines if the current incoming TSC parameters need to be adjusted. For example, the network node may determine that the Burst Arrival Time needs to be adjusted with an Offset, so that the scheduler in gNB could avoid handling the transmissions of all the UEs arriving at the same time and causing congestion. As another example, the network node may determine that the periodicity needs to be adjusted with an offset.

Table 3 provides an example IE that may be incorporated into 3GPP TS 38.413, Chapter 9.3.4.2 for enabling a network node such as a gNB to feedback the offset values towards the TSCAI received from CN in the response message, according to certain embodiments. In a particular embodiment, the CN may take the offset values transmitted by the gNB into account.

TABLE 3

| | | | | | | |
|---|---|---|---|---|---|---|
| | | | IE type | | | |
| IE/Group | | | and | Semantics | | Assigned |
| Name | Presence | Range | reference | description | Criticality | Criticality |

| | | | |
|---|---|---|---|
| DL QoS | M | QoS Flow | — |
| Flow per | | per TNL | |
| TNL | | Information | |
| Information | | 9.3.2.8 | |

Skip the unchanged IEs

| | | | | | |
|---|---|---|---|---|---|
| MBS | O | | 9.3.1.214 | YES | ignore |
| Session | | | | | |
| Failed to | | | | | |
| Setup List | | | | | |
| TSCAI | | 0 . . . 1 | | YES | reject |
| Feedback | | | | | |
| >TSCAI | | <1 . . . maxNoOfQoS> | | | |
| feedback | | | | | |
| per QoS | | | | | |
| Items | | | | | |
| >>TSC | O | | New | YES | reject |
| Assistance | | | | | |
| Information | | | | | |
| Feedback | | | | | |
| Downlink | | | | | |
| >>TSC | O | | New | YES | reject |
| Assistance | | | | | |
| Information | | | | | |
| Feedback | | | | | |
| Uplink | | | | | |

Table 4 provides another example information element that may be incorporated into 3GPP TS 38.413, Chapter 9.3.4.2 for enabling a network node such as a gNB to provide TSCAI feedback information, according to certain embodiments.

TABLE 4

| | | | | |
|---|---|---|---|---|
| | | | IE type and | |
| IE/Group Name | Presence | Range | reference | Semantics description |

| | | | |
|---|---|---|---|
| Periodicity offset | O | OCTET | Encoded in the same |
| | | STRING | format as the |
| | | | ReferenceTime IE as |
| | | | defined in TS 38.331 [18]. |
| | | | The value is truncated to |
| | | | 1 us granularity. |
| Burst Arrival Time | O | INTEGER | Periodicity expressed in |
| Offset | | (0 . . . 640000, . . . ) | units of 1 us. |

In a particular embodiment, when alternative TSC information is provided from the CN to the network node such as, for example, the gNB, the network node may choose the best one that suits its resource and also alternatives that it may accept. The alterative can be used when there will be further modification of TSC.

In another particular embodiment, the network node such as, for example, the gNB collects the information from UE and includes them in the response to CN.

In another particular embodiment, the network node such as, for example, the gNB notifies the CN that the situation in the gNB has been changed and/or that a new set of TSC parameters are preferred. In a particular embodiment, an example implementation is to include the new feedback in the Packet Data Unit (PDU) session Notify procedure.

In the split NG-RAN architecture, the TSCAI feedback information, as in above, is sent from gNB-DU where the scheduler locates to gNB-CU over F1AP, for example, during UE context setup or modification for the given QoS flow or DRB.

### UE Embodiments

According to certain embodiments, the network node such as, for example, the gNB transfers (i.e., transmits) the TSCAI, which may or may not be received from the CN as described above, to a UE and may additionally indicate that the UE is allowed to provide feedback.

According to certain additional or alternative embodiments, the UE indicates directly to CN the offset or range parameters that is tolerable. For example, the UE may inform the CN about a preferred first Burst Arrival time and a range parameter, W, such that a second Burst Arrival time is tolerable:

First Burst Arrival time−W≤Second Burst Arrival time≤First Burst Arrival time+W

In such embodiments, the CN then lets the network node such as, for example, the gNB to choose the second Burst Arrival time and then informs the UE to use the second Burst Arrival time.

In some examples, the CN receives an indication from the NG-RAN if the NG-RAN cannot maintain required QoS that the UE is admitted. In such examples, the CN rejects the service request from UE.

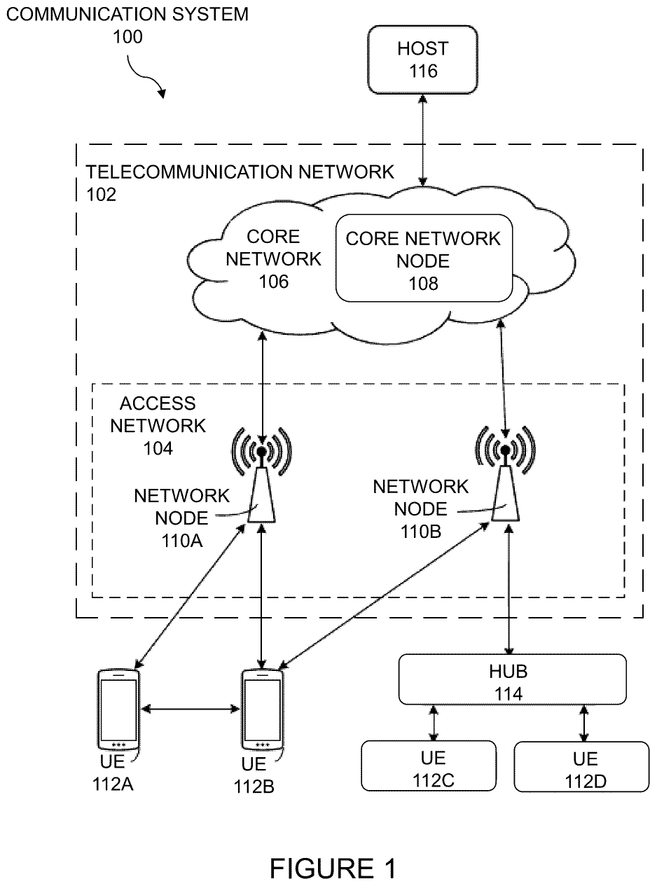

FIG. 1 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

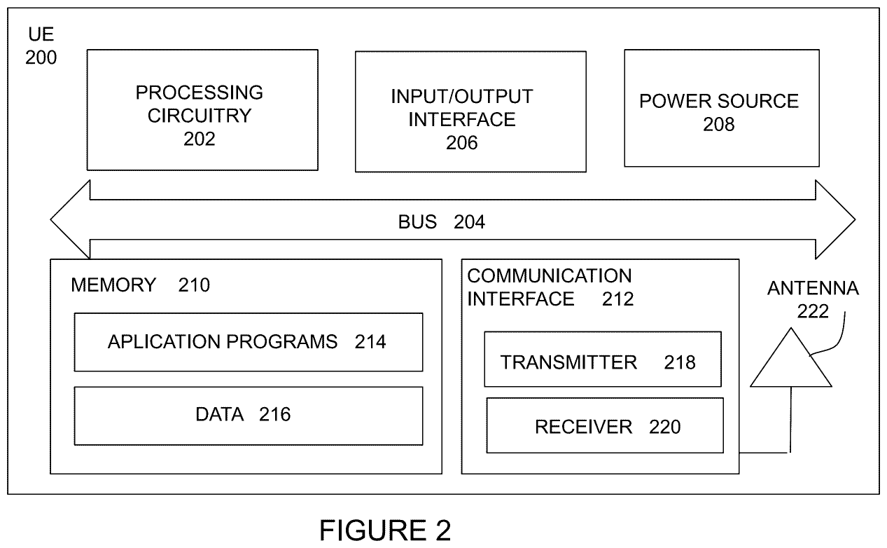

FIG. 2 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 2. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or include a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

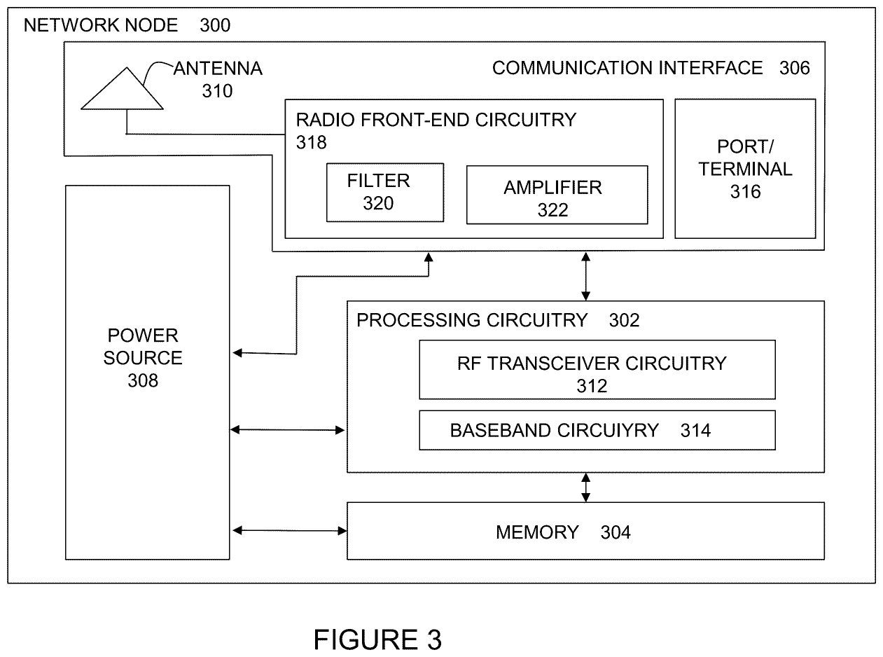

FIG. 3 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 3 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

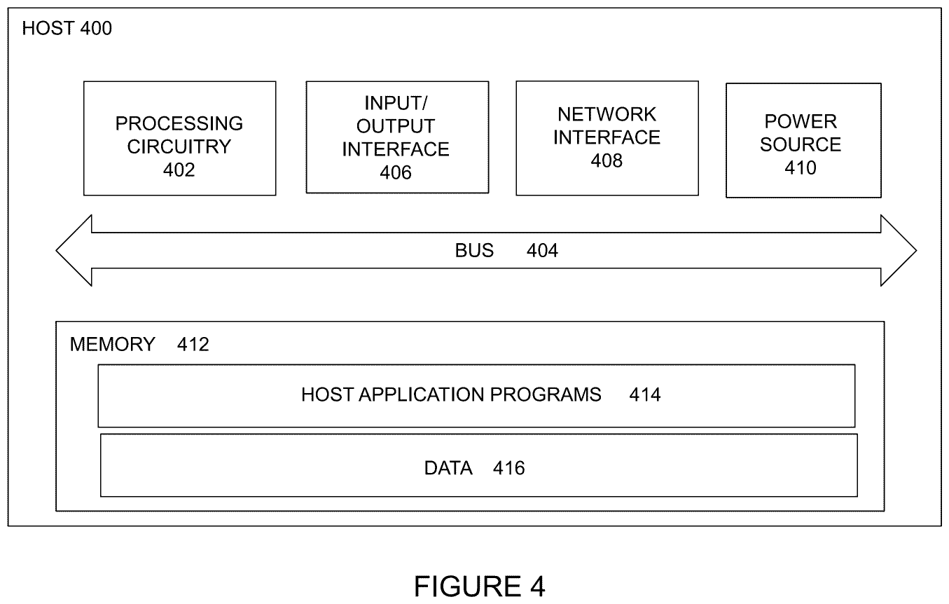

FIG. 4 is a block diagram of a host 400, which may be an embodiment of the host 116 of FIG. 1, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

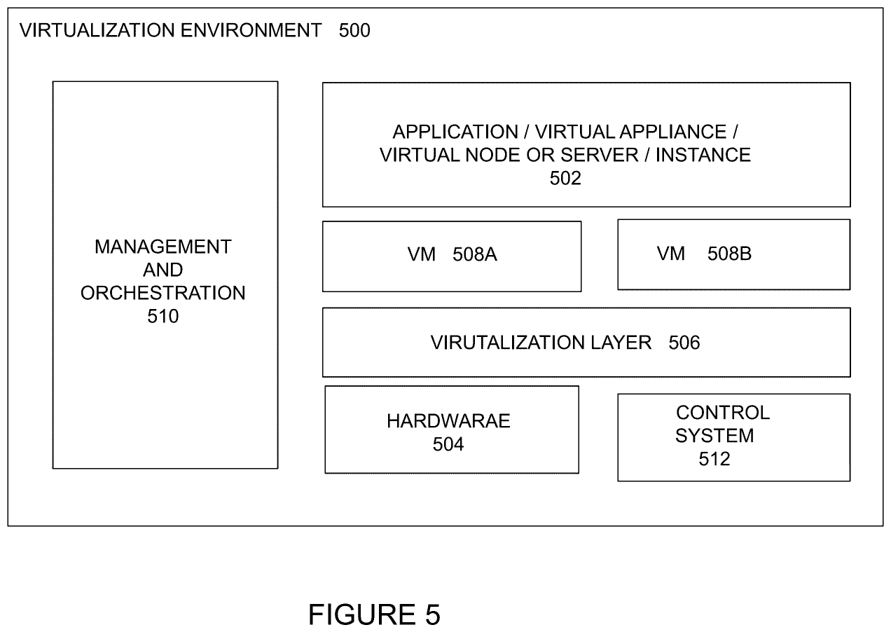

FIG. 5 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

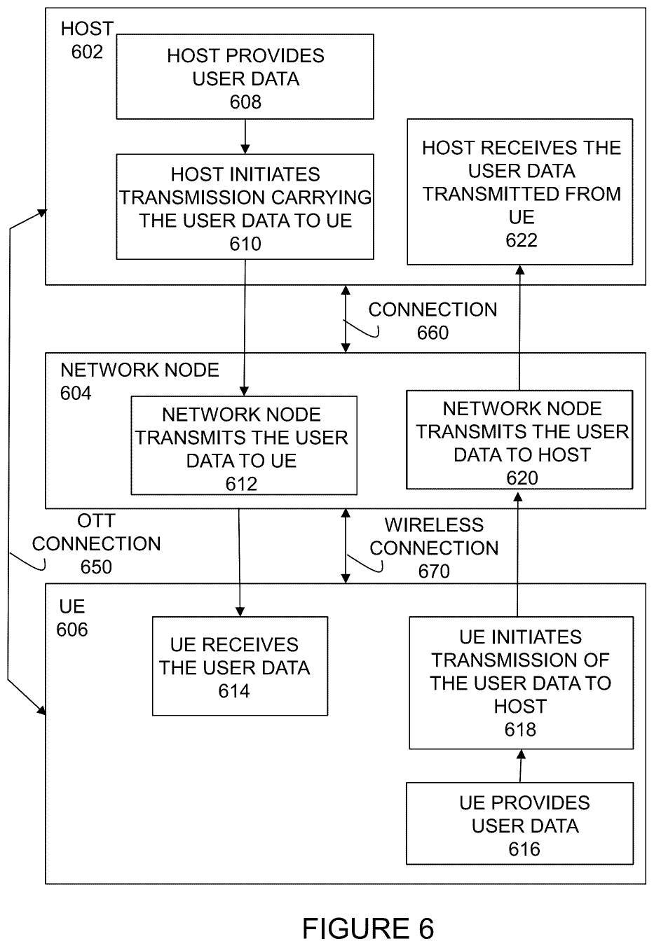

FIG. 6 shows a communication diagram of a host 602 communicating via a network node 604 with a UE 606 over a partially wireless connection in accordance with some embodiments. Example implementations, in accordance with various embodiments, of the UE (such as a UE 112a of FIG. 1 and/or UE 200 of FIG. 2), network node (such as network node 110a of FIG. 1 and/or network node 300 of FIG. 3), and host (such as host 116 of FIG. 1 and/or host 400 of FIG. 4) discussed in the preceding paragraphs will now be described with reference to FIG. 6.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 1) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

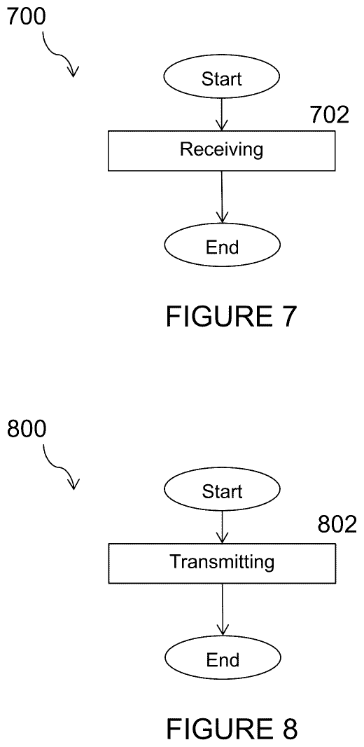

FIG. 7 illustrates an example method 700 by a UE 112 for negotiating parameters associated with a TSC, according to certain embodiments. In the illustrated embodiment, the method 700 includes a receiving step at 702. For example, at step 702, the UE 112 may receive, from at least one network node 108, 110, at least one of: assistance information for adjusting at least one TSCAI parameter associated with a first set of TSCAI parameters; and a second set of TSCAI parameters.

In a particular embodiment, the at least one network node may include a core network node or another node associated with the core network and/or a gNB or other access node.

In various particular embodiments, the method may further include any of the features and/or operations or any combination thereof of the Group A and/or C Example Embodiments provided below.

FIG. 8 illustrates an example method 800 by a network node 108, 110 for negotiating parameters associated with a TSC, according to certain embodiments. In the illustrated embodiment, the method 800 includes a transmitting step at 802. For example, at step 802, the network node 110 may transmit, to another network node, at least one of: assistance information for adjusting at least one TSCAI parameter in a first set of TSCAI parameters; and a second set of TSCAI parameters.

In a particular embodiment, the network node 108, 110 may include a core network node or another node associated with the core network. In a particular embodiment, the other network node may include a gNB or other access node.

In various particular embodiments, the method may further include any of the features and/or operations or any combination thereof of the Group B and/or D Example Embodiments provided below.

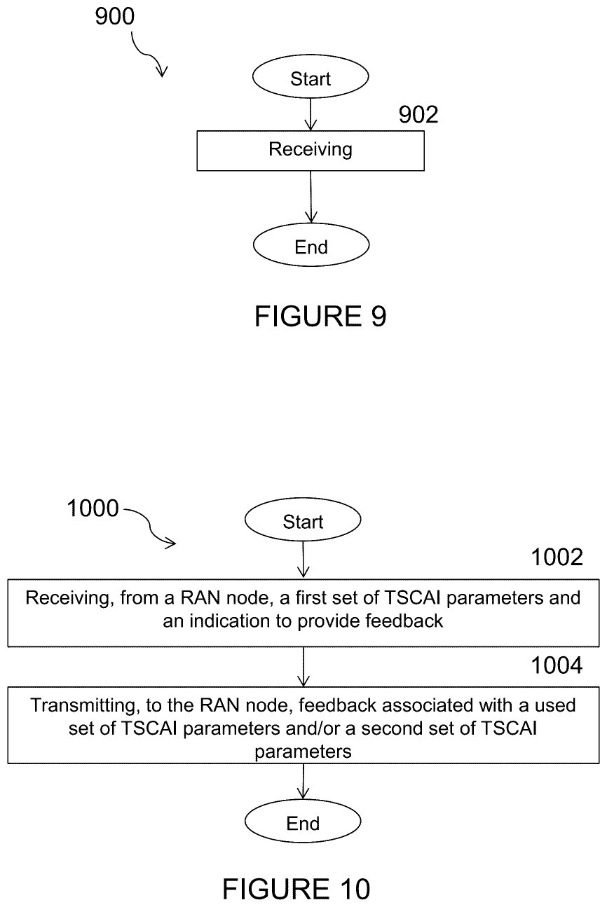

FIG. 9 illustrates an example method 900 by a network node 110 for negotiating parameters associated with a TSC, according to certain embodiments. In the illustrated embodiment, the method includes a receiving step at 902. For example, at step 902, the network node 110 may receive, from another network node 108, at least one of: assistance information for adjusting at least one TSCAI parameter in a first set of TSCAI parameters; and a second set of TSCAI parameters.

In a particular embodiment, the network node may include a RAN node such as a gNB or an access node. In a particular embodiment, the other network node may include a CN node or another node associated with the CN.

In various particular embodiments, the method may further include any of the features and/or operations or any combination thereof of the Group B and/or E Example Embodiments provided below.

FIG. 10 illustrates another example method 1000 by a UE 112 for negotiating parameters associated with a TSC, according to certain embodiments. As illustrated, the method begins at step 1002 when the UE 112 receives, from a RAN node 110, a first set of TSCAI parameters and an indication to provide feedback. At step 1004, the UE 112 transmits, to the RAN node 110, feedback associated with a used set of TSCAI parameters and/or a second set of TSCAI parameters.

In a particular embodiment, the UE 112 receives, from the RAN node 110, the second set of TSCAI parameters.

In a particular embodiment, the second set of TSCAI parameters comprises at least one parameter that is different from at least one parameter in the first set of TSCAI parameters.

In a particular embodiment, at least one of the first set of TSCAI parameters and the second set of TSAI parameters comprise at least one of: at least one value and/or range of values associated with a flow direction; at least one value and/or range of values associated with a periodicity; at least one value and/or range of values associated with a burst arrival time; and at least one value and/or range of values associated with a survival time.

In a particular embodiment, the UE 112 uses the first set of TSCAI parameters for at least one QoS flow. Additionally or alternatively, the UE 112 uses an adjusted set of TSCAI parameters for at least one QoS flow, and the adjusted set of TSACI parameters is obtained by adjusting the first set of TSCAI parameters based on assistance information received from the RAN node. Additionally or alternatively, the UE 112 uses the second set of TSCAI parameters for at least one QoS flow.

In a further particular embodiment, when using the first set of TSCAI parameters, the adjusted set of TSCAI parameters, or the second set of TSCAI parameters, the UE 112 transmits or receives a signal using an accepted parameter from the first set of TSCAI parameters, the adjusted set of TSCAI parameters or the second set of TSCAI parameters, respectively.

In a further particular embodiment, the UE 112 selects one of the first set of TSCAI parameters, the adjusted set of TSCAI parameters, and/or the second set of TSCAI parameters to use for the at least one QoS flow.

In a particular embodiment, when selecting the one of the first set of TSCAI parameters, the adjusted set of TSCAI parameters, and/or the second set of TSCAI parameters, the UE 112 selects a best one of the first set of TSCAI parameters, the adjusted set of TSCAI parameters, and/or the second set of TSCAI parameters based on at least one of: at least one available radio resource; an amount of network congestion and/or load; and an amount of data to be received from and/or transmitted to the at least one network node.

In a particular embodiment, the feedback indicates at least one of: the UE used the first set of TSCAI parameters for at least one QoS flow; the UE used an adjusted set of TSCAI parameters for at least one QoS flow; and the UE used the second set of TSCAI parameters for at least one QoS flow.

In a particular embodiment, the UE 112 receives a request for the feedback from the RAN node 110, and the feedback is transmitted to the RAN node based on the request and/or indication.

In a particular embodiment, the UE 112 determines to transmit a request for additional assistance information and/or a third set of TSCAI parameters based on at least one of: at least one available radio resource; an amount of network congestion and/or load; and an amount of data to be received from and/or transmitted to the RAN node.

In a particular embodiment, the UE 112 transmits, to the RAN node 110, capability information indicating at least one TSCAI parameter and/or range of TSCAI parameters that the UE is able to use.

In a particular embodiment, the UE 112 transmits, to the RAN node 110, an offset to be applied to at least one TSCAI parameter in the first set of TSCAI parameters.

In a particular embodiment, the UE 112 receives, from the RAN node 110, information indicating that at least one of the first set of TSCAI parameters and the second set of TSCAI parameters may not be modified or negotiated by the UE.

In a particular embodiment, the feedback is transmitted to a CN node 108 via the RAN node 110.

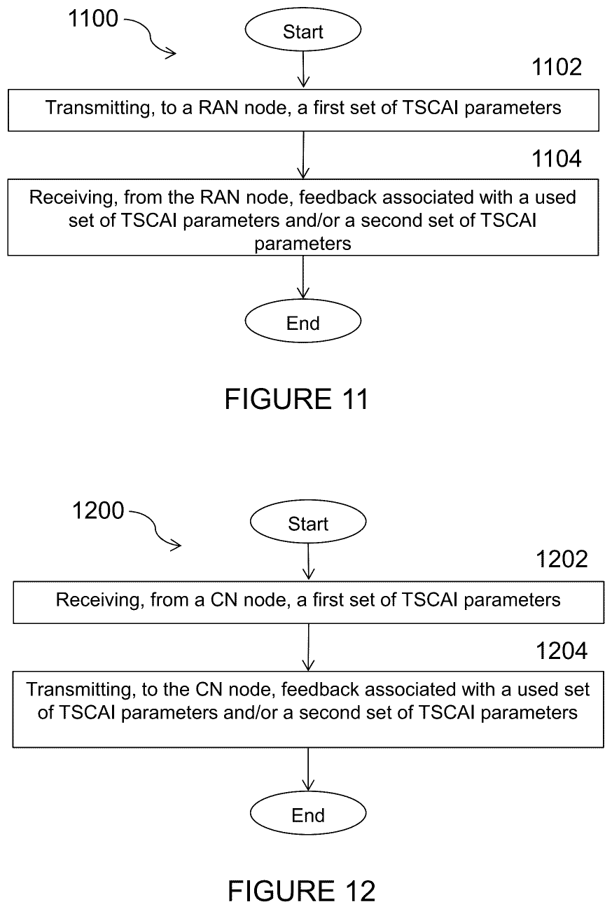

FIG. 11 illustrates another example method 1100 by a CN node 108 for negotiating parameters associated with a TSC, according to certain embodiments. As illustrated, the method begins at step 1102 when the CN node 108 transmits, to a RAN node 110, a first set of TSCAI parameters. At step 1104, the CN node 108 receives, from the RAN node 110, feedback associated with a used set of TSCAI parameters and/or a second set of TSCAI parameters.

In a particular embodiment, the CN node 108 transmits to the RAN node 110 the second set of TSCAI parameters.

In a particular embodiment, the second set of TSCAI parameters includes at least one parameter that is different from at least one parameter in the first set of TSCAI parameters.

In a particular embodiment, at least one of the first set of TSCAI parameters and the second set of TSAI parameters include at least one of: at least one value and/or range of values associated with a flow direction; at least one value and/or range of values associated with a periodicity; at least one value and/or range of values associated with a burst arrival time; and at least one value and/or range of values associated with a survival time.

In a particular embodiment, the feedback indicates that the RAN node 110 and/or the UE 112 used the first set of TSCAI parameters for at least one QoS flow. Additionally or alternatively, the feedback indicates that the RAN node 110 and/or the UE 112 used an adjusted set of TSCAI parameters for at least one QoS flow, and the adjusted set of TSACI parameters is obtained by adjusting the first set of TSCAI parameters based on assistance information. Additionally or alternatively, the feedback indicates that the other network node used the second set of TSCAI parameters for at least one QoS flow.

In a particular embodiment, the CN node 108 transmits the feedback from the RAN node 110 to a service application level.

In a particular embodiment, the feedback is from the UE 112 associated with the at least one QoS flow.

In a particular embodiment, the CN node 108 receives, from the RAN node 110, capability information indicating at least one TSCAI parameter and/or range of TSCAI parameters that the RAN node 110 and/or the UE 112 is able to use.

In a particular embodiment, the CN node 108 receives, from the RAN node 110, an offset to be applied to at least one TSCAI parameter in the first set of TSCAI parameters.

In a particular embodiment, the CN node 108 transmits, to the RAN node 110, information indicating that at least one of the first set of TSCAI parameters and the second set of TSCAI parameters may not be modified or negotiated by the RAN node 110.

FIG. 12 illustrates another example method 1200 by a RAN node 110 for negotiating parameters associated with a TSC, according to certain embodiments. As illustrated, the method 1200 begins at step 1202 when the RAN node 110 receives, from a CN node 108, a first set of TSCAI parameters. At step 1204, the RAN node 110 transmits, to the CN node 108, feedback associated with a used set of TSCAI parameters and/or a second set of TSCAI parameters. In a particular embodiment, the RAN node 110 receives, from a UE 112, the second set of TSCAI parameters.

In a particular embodiment, the second set of TSCAI parameters includes at least one parameter that is different from at least one parameter in the first set of TSCAI parameters.

In a particular embodiment, at least one of the first set of TSCAI parameters and the second set of TSAI parameters include at least one of: at least one value and/or range of values associated with a flow direction; at least one value and/or range of values associated with a periodicity; at least one value and/or range of values associated with a burst arrival time; and at least one value and/or range of values associated with a survival time.

In a particular embodiment, the RAN node 110 uses the first set of TSCAI parameters for at least one QoS flow. Additionally or alternatively, the RAN node 110 uses an adjusted set of TSCAI parameters for at least one QoS flow, and the adjusted set of TSACI parameters is obtained by adjusting the first set of TSCAI parameters based on assistance information transmitted to the UE. Additionally or alternatively, the RAN node 110 uses the second set of TSCAI parameters for at least one QoS flow.

In a particular embodiment, when using the first set of TSCAI parameters, the adjusted set of TSCAI parameters or the second set of TSCAI parameters, the RAN node 110 transmits or receives a signal using an accepted parameter from the first set of TSCAI parameters, the adjusted set of TSCAI parameters or the second set of TSCAI parameters, respectively.

In a particular embodiment, the RAN node 110 selects one of the first set of TSCAI parameters, the adjusted set of TSCAI parameters, and/or the second set of TSCAI parameters to use for the at least one QoS flow based on at least one of: at least one available radio resource; an amount of network congestion and/or load; an amount of data to be received and/or transmitted by the RAN node 110; and an amount of data to be received and/or transmitted by a plurality of user equipments, UEs, served by the RAN node 110.

In a particular embodiment, the feedback indicates at least one of: the RAN node 110 used the first set of TSCAI parameters for at least one QoS flow; the RAN node 110 used an adjusted set of TSCAI parameters for at least one QoS flow; and the RAN node 110 used the second set of TSCAI parameters for at least one QoS flow.

In a particular embodiment, the RAN node 110 receives additional feedback from a UE 112 associated with the at least one QoS flow, and the feedback transmitted to the CN node 108 includes the additional feedback from the UE.

In a particular embodiment, when transmitting the feedback, the RAN node 110 transmits the feedback from a distributed unit of the RAN node 110 to a centralized unit of the RAN node 110. Additionally or alternatively, the RAN node 110 transmits the feedback from the centralized unit of the RAN node to the CN node.

In a particular embodiment, the RAN node 110 determines to transmit a request for assistance information and/or a third set of TSCAI parameters based on at least one of: at least one available radio resource; an amount of network congestion and/or load; an amount of data to be received and/or transmitted by the RAN node 110; and an amount of data to be received and/or transmitted by a plurality of user equipments (UEs) served by the RAN node 110.

In a particular embodiment, the RAN node 110 transmits, to the CN node 108, capability information indicating at least one TSCAI parameter and/or range of TSCAI parameters that the RAN node 110 is able to use.

In a particular embodiment, the RAN node 110 transmits, to the CN node 108, an offset to be applied to at least one TSCAI parameter in the first set of TSCAI parameters.

In a particular embodiment, the RAN node 110 transmits, to the CN node 108, a request for assistance information and/or the second set of TSCAI parameters.

In a particular embodiment, the RAN node 110 receives, from the CN node 108, information indicating that at least one of the first set of TSCAI parameters and the second set of TSCAI parameters may not be modified or negotiated by the RAN node 110.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment for negotiating parameters associated with a time sensitive communication (TSC), the method comprising any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for negotiating parameters associated with a time sensitive communication (TSC), the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) for negotiating parameters associated with a time sensitive communication (TSC), the method comprising: receiving, from at least one network node, at least one of: assistance information for adjusting at least one TSC assistance information (TSCAI) parameter associated with a first set of TSCAI parameters; and a second set of TSC assistance information (TSCAI) parameters.

Example Embodiment C2. The method of Example Embodiment C1, comprising: prior to receiving the alternative set of TSCAI parameters, receiving the first set of TSCAI parameters from the at least one network node.

Example Embodiment C3. The method of Example Embodiment C2, wherein the second set of TSCAI parameters comprises at least one parameter that is different from at least one parameter in the first set of TSCAI parameters.

Example Embodiment C4. The method of any one of Example Embodiments C to C3, wherein the second set of TSCAI parameters is to be used as an alternative to the first set of TSCAI parameters.

Example Embodiment C5. The method of any one of Example Embodiments C1 to C4, wherein at least one of the first set of TSCAI parameters and the second set of TSAI parameters comprise at least one of: at least one value and/or range of values associated with a flow direction; at least one value and/or range of values associated with a periodicity; at least one value and/or range of values associated with a burst arrival time; and at least one value and/or range of values associated with a survival time.

Example Embodiment C6. The method of any one of Example Embodiments C1 to C5, wherein the receiving step is performed during a setup of a Quality of Service (QoS) flow.

Example Embodiment C7. The method of any one of Example Embodiments C1 to C5, wherein the receiving step is performed during a modification of a previously established Quality of Service (QoS) flow.

Example Embodiment C8. The method of any one of Example Embodiments C1 to C7, comprising at least one of: using the first set of TSCAI parameters for at least one QoS flow; using an adjusted set of TSCAI parameters for at least one QoS flow, wherein the adjusted set of TSACI parameters is obtained by adjusting the first set of TSCAI parameters based on the assistance information; and using the second set of TSCAI parameters for at least one QoS flow.

Example Embodiment C9. The method of Example Embodiment C8, wherein using the first set of TSCAI parameters, the adjusted set of TSCAI parameters or the second set of TSCAI parameters comprises transmitting or receiving a signal using an accepted parameter from the first set of TSCAI parameters, the adjusted set of TSCAI parameters or the second set of TSCAI parameters, respectively.

Example Embodiment C10. The method of any one of Example Embodiments C8 to C9, comprising adjusting the first set of TSCAI parameters based on the assistance information to obtain the adjusted set of TSCAI parameters.

Example Embodiment C11. The method of any one of Example Embodiments C1 to C10, comprising determining whether to use the first set of TSCAI parameters, the adjusted set of TSCAI parameters, and/or the second set of TSCAI parameters for at least one QoS flow.

Example Embodiment C12. The method of Example Embodiment C11, wherein determining whether to use the first set of TSCAI parameters, the adjusted set of TSCAI parameters, and/or the second set of TSCAI parameters for at least one QoS flow comprises selecting a best one of the first set of TSCAI parameters, the adjusted set of TSCAI parameters, and/or the second set of TSCAI parameters.

Example Embodiment C13. The method of any one of Example Embodiments C11 to C12, wherein the determining is based on at least one of: at least one available radio resource; an amount of network congestion and/or load; an amount of data to be received from and/or transmitted to the at least one network node.

Example Embodiment C14. The method of any one of Example Embodiments C1 to C13, comprising transmitting feedback to the at least one network node, wherein the feedback indicates at least one of: the UE used the first set of TSCAI parameters for at least one QoS flow; the UE used an adjusted set of TSCAI parameters for at least one QoS flow, wherein the adjusted set of TSACI parameters is obtained by adjusting the first set of TSCAI parameters based on the assistance information; and the UE used the second set of TSCAI parameters for at least one QoS flow.

Example Embodiment C15. The method of Example Embodiment C14, comprising at least one of: receiving a request for the feedback from the at least one network node, and receiving an indication that the UE can send feedback to the at least one network node, and wherein the feedback is transmitted to the at least one network node based on the request and/or indication.

Example Embodiment C16. The method of any one of Example Embodiments C14 to C15, wherein transmitting the feedback to the at least one network node comprises transmitting the feedback to a distributed unit of the at least one network node.

Example Embodiment C17. The method of any one of Example Embodiments C14 to C16, wherein the feedback comprises a request for additional assistance information and/or a third set of TSCAI parameters.

Example Embodiment C18. The method of Example Embodiment C17, comprising determining to transmit the request for the additional assistance information and/or the third set of TSCAI parameters based on at least one of: at least one available radio resource; an amount of network congestion and/or load; an amount of data to be received from and/or transmitted to the at least one network node.

Example Embodiment C19. The method of any one of Example Embodiment C1 to C18, comprising: transmitting, to the at least one network node, capability information indicating at least one TSCAI parameter and/or range of TSCAI parameters that the UE is able to use.

Example Embodiment C20. The method of Example Embodiment C19, wherein: the at least one TSCAI parameter and/or range of TSCAI parameters indicated in the capability information is a same as or overlaps with at least one TSCAI parameter in the second set of TSCAI parameters; and the at least one TSCAI parameter and/or range of TSCAI parameters indicated in the capability information is a same as or overlaps with at least one TSCAI parameter in the first set of TSCAI parameters after the first set of TSCAI parameters is adjusted based on the assistance information.

Example Embodiment C21. The method of any one of Example Embodiments C19 to C20, comprising: receiving, from the at least one network node, a request for the capability information, wherein the capability information is transmitted based on the request.

Example Embodiment C22. The method of any one of Example Embodiments C19 to C21, wherein the at least one TSCAI parameter and/or range of TSCAI parameters indicated in the capability information comprises at least one of: at least one value and/or range of values associated with a flow direction; at least one value and/or range of values associated with a periodicity; at least one value and/or range of values associated with a burst arrival time; and at least one value and/or range of values associated with a survival time.

Example Embodiment C23. The method of any one of Example Embodiments C1 to C22, comprising: transmitting, to the at least one network node, an offset to be applied to at least one TSCAI parameter in the first set of TSCAI parameters.

Example Embodiment C24. The method of Example Embodiment C23, comprising: receiving, from the at least one network node, a request for the offset.

Example Embodiment C25. The method of any one of Example Embodiments C1 to C24, comprising: transmitting, to the at least one network node, a request for the assistance information and/or the second set of TSCAI parameters.

Example Embodiment C26. The method of Example Embodiment C25, comprising determining to transmit the request for the assistance information and/or the second set of TSCAI parameters based on at least one of: at least one available radio resource; an amount of network congestion and/or load; an amount of data to be received from and/or transmitted to the network node.

Example Embodiment C27. The method of any one of Example Embodiments C1 to C26, comprising: receiving, from the at least one network node, information indicating that at least one of the first set of TSCAI parameters and the second set of TSCAI parameters may not be modified or negotiated by the UE.

Example Embodiment C28. The method of any one of Example Embodiments C1 to C27, wherein the first set of TSCAI parameters and/or the second set of TSCAI parameters comprises: at least one value for an associated TSCAI parameter; and/or information for determining a range of values for an associated TSCAI parameter.

Example Embodiment C29. The method of any one of Example Embodiments C1 to C28, wherein the at least one network node comprises a gNodeB (gNB).

Example Embodiment C30. The method of any one of Example Embodiments C1 to C29, wherein the assistance information and/or the second set of TSCAI parameters are received from the gNB.

Example Embodiment C31. The method of any one of Example Embodiments C1 to C30, wherein the at least one network node comprises a core network (CN) node and/or is associated with a CN.

Example Embodiment C32. The method of any one of Example Embodiments C1 to C31, wherein the feedback is transmitted to the CN and/or the gNB.

Example Embodiment C33. The method of Example Embodiments C1 to C32, further comprising: providing user data; and forwarding the user data to a host via the transmission to the network node.

Example Embodiment C34. A user equipment comprising processing circuitry configured to perform any of the methods of Example Embodiments C1 to C33.

Example Embodiment C35. A user equipment configured to perform any of the methods of Example Embodiments C1 to C33.

Example Embodiment C36. A wireless device comprising processing circuitry configured to perform any of the methods of Example Embodiments C1 to C33.

Example Embodiment C37. A computer program comprising instructions which when executed on a computer perform any of the methods of Example Embodiments C1 to C33.

Example Embodiment C38. A computer program product comprising computer program, the computer program comprising instructions which when executed on a computer perform any of the methods of Example Embodiments C1 to C33.

Example Embodiment C39. A non-transitory computer readable medium storing instructions which when executed by a computer perform any of the methods of Example Embodiments C1 to C33.

### Group D Example Embodiments

Example Embodiment D1. A method by a network node for negotiating parameters associated with a time sensitive communication (TSC), the method comprising: transmitting, to another network node, at least one of: assistance information for adjusting at least one TSC assistance information (TSCAI) parameter in a first set of TSCAI parameters; and a second set of TSC assistance information (TSCAI) parameters.

Example Embodiment D2. The method of Example Embodiment D1, comprising: prior to transmitting the alternative set of TSCAI parameters, transmitting to the other network node the first set of TSCAI parameters.

Example Embodiment D3. The method of Example Embodiment D2, wherein the second set of TSCAI parameters comprises at least one parameter that is different from at least one parameter in the first set of TSCAI parameters.

Example Embodiment D4. The method of any one of Example Embodiments D1 to D3, wherein the second set of TSCAI parameters is to be used as an alternative to the first set of TSCAI parameters.

Example Embodiment D5. The method of any one of Example Embodiments D1 to D4, wherein at least one of the first set of TSCAI parameters and the second set of TSAI parameters comprise at least one of: at least one value and/or range of values associated with a flow direction; at least one value and/or range of values associated with a periodicity; at least one value and/or range of values associated with a burst arrival time; and at least one value and/or range of values associated with a survival time.

Example Embodiment D6. The method of any one of Example Embodiments D1 to D5, wherein the transmitting step is performed during a setup of a Quality of Service (QoS) flow.

Example Embodiment D7. The method of any one of Example Embodiments D1 to D5, wherein the transmitting step is performed during a modification of a previously established Quality of Service (QoS) flow.

Example Embodiment D8. The method of any one of Example Embodiments D1 to D7, comprising receiving feedback from the other network node, wherein the feedback indicates at least one of: the other network node used the first set of TSCAI parameters for at least one QoS flow; the other network node used an adjusted set of TSCAI parameters for at least one QoS flow, wherein the adjusted set of TSACI parameters is obtained by adjusting the first set of TSCAI parameters based on the assistance information; and the other network node used the second set of TSCAI parameters for at least one QoS flow.

Example Embodiment D9. The method of Example Embodiment D8, comprising transmitting the feedback from the other network node to a service application level.

Example Embodiment D10. The method of any one of Example Embodiments D8 to D9, wherein the feedback comprises feedback from a user equipment (UE) associated with the at least one QoS flow.

Example Embodiment D11. The method of any one of Example Embodiment D1 to D10, comprising: receiving, from the other network node, capability information indicating at least one TSCAI parameter and/or range of TSCAI parameters that the other network node is able to use.

Example Embodiment D12. The method of Example Embodiment D11, wherein: the at least one TSCAI parameter and/or range of TSCAI parameters indicated in the capability information is a same as or overlaps with at least one TSCAI parameter in the second set of TSCAI parameters; and the at least one TSCAI parameter and/or range of TSCAI parameters indicated in the capability information is a same as or overlaps with at least one TSCAI parameter in the first set of TSCAI parameters after the first set of TSCAI parameters is adjusted based on the assistance information.

Example Embodiment D13. The method of any one of Example Embodiments D11 to D12, comprising: transmitting, to the other network node, a request for the capability information.

Example Embodiment D14. The method of any one of Example Embodiments D1 to D13, comprising: receiving, from the other network node, an offset to be applied to at least one TSCAI parameter in the first set of TSCAI parameters.

Example Embodiment D15. The method of Example Embodiment D14, comprising: transmitting, to the other network node, a request for the offset.

Example Embodiment D16. The method of any one of Example Embodiments D1 to D10, comprising: transmitting, to the other network node, information indicating that at least one of the first set of TSCAI parameters and the second set of TSCAI parameters may not be modified or negotiated by the other network node.

Example Embodiment D17. The method of any one of Example Embodiments D1 to D16, wherein the first set of TSCAI parameters and/or the second set of TSCAI parameters comprises: at least one value for an associated TSCAI parameter; and/or information for determining a range of values for an associated TSCAI parameter.

Example Embodiment D18. The method of any one of Example Embodiments D1 to D17, wherein the network node comprises a core network (CN) node and/or is associated with a CN.

Example Embodiment D19. The method of any one of Example Embodiments D1 to D18, wherein the other network node comprises a gNodeB (gNB).

Example Embodiment D20. The method of any one of Example Embodiments D1 to D19, further comprising: obtaining user data; and forwarding the user data to a host or a user equipment.

Example Embodiment D21. A network node comprising processing circuitry configured to perform any of the methods of Example Embodiments D1 to D20.

Example Embodiment D22. A network node configured to perform any of the methods of Example Embodiments D1 to D20.

Example Embodiment D23. A computer program comprising instructions which when executed on a computer perform any of the methods of Example Embodiments D1 to D20.

Example Embodiment D24. A computer program product comprising computer program, the computer program comprising instructions which when executed on a computer perform any of the methods of Example Embodiments D1 to D20.

Example Embodiment D25. A non-transitory computer readable medium storing instructions which when executed by a computer perform any of the methods of Example Embodiments D1 to D20.

### Group E Example Embodiments

Example Embodiment E1. A method by a network node for negotiating parameters associated with a time sensitive communication (TSC), the method comprising: receiving, from another network node, at least one of: assistance information for adjusting at least one TSC assistance information (TSCAI) parameter in a first set of TSCAI parameters; and a second set of TSC assistance information (TSCAI) parameters.

Example Embodiment E2. The method of Example Embodiment E1, comprising: prior to receiving the alternative set of TSCAI parameters, receiving the first set of TSCAI parameters from the other network node.

Example Embodiment E3. The method of Example Embodiment E2, wherein the second set of TSCAI parameters comprises at least one parameter that is different from at least one parameter in the first set of TSCAI parameters.

Example Embodiment E4. The method of any one of Example Embodiments E1 to E3, wherein the second set of TSCAI parameters is to be used as an alternative to the first set of TSCAI parameters.

Example Embodiment E5. The method of any one of Example Embodiments E1 to E4, wherein at least one of the first set of TSCAI parameters and the second set of TSAI parameters comprise at least one of: at least one value and/or range of values associated with a flow direction; at least one value and/or range of values associated with a periodicity; at least one value and/or range of values associated with a burst arrival time; and at least one value and/or range of values associated with a survival time.

Example Embodiment E6. The method of any one of Example Embodiments E1 to E5, wherein the receiving step is performed during a setup of a Quality of Service (QoS) flow.

Example Embodiment E7. The method of any one of Example Embodiments E1 to E5, wherein the receiving step is performed during a modification of a previously established Quality of Service (QoS) flow.

Example Embodiment E8. The method of any one of Example Embodiments E1 to E7, comprising at least one of: using the first set of TSCAI parameters for at least one QoS flow; using an adjusted set of TSCAI parameters for at least one QoS flow, wherein the adjusted set of TSACI parameters is obtained by adjusting the first set of TSCAI parameters based on the assistance information; and using the second set of TSCAI parameters for at least one QoS flow.

Example Embodiment E9. The method of Example Embodiment E8, wherein using the first set of TSCAI parameters, the adjusted set of TSCAI parameters or the second set of TSCAI parameters comprises transmitting or receiving a signal using an accepted parameter from the first set of TSCAI parameters, the adjusted set of TSCAI parameters or the second set of TSCAI parameters, respectively.

Example Embodiment E10. The method of Example Embodiment E9, comprising adjusting the first set of TSCAI parameters based on the assistance information to obtain the adjusted set of TSCAI parameters.

Example Embodiment E11. The method of any one of Example Embodiments E1 to E10, comprising determining whether to use the first set of TSCAI parameters, the adjusted set of TSCAI parameters, and/or the second set of TSCAI parameters for at least one QoS flow.

Example Embodiment E12. The method of Example Embodiment E11, wherein determining whether to use the first set of TSCAI parameters, the adjusted set of TSCAI parameters, and/or the second set of TSCAI parameters for at least one QoS flow comprises selecting a best one of the first set of TSCAI parameters, the adjusted set of TSCAI parameters, and/or the second set of TSCAI parameters.

Example Embodiment E13. The method of any one of Example Embodiments E11 to E12, wherein the determining is based on at least one of: at least one available radio resource; an amount of network congestion and/or load; an amount of data to be received and/or transmitted by the network node; and an amount of data to be received and/or transmitted by a plurality of user equipments (UEs) served by the network node.

Example Embodiment E14. The method of any one of Example Embodiments E1 to E13, comprising transmitting feedback to the other network node, wherein the feedback indicates at least one of: the network node used the first set of TSCAI parameters for at least one QoS flow; the network node used an adjusted set of TSCAI parameters for at least one QoS flow, wherein the adjusted set of TSACI parameters is obtained by adjusting the first set of TSCAI parameters based on the assistance information; and the network node used the second set of TSCAI parameters for at least one QoS flow.

Example Embodiment E15. The method of Example Embodiment E14, comprising receiving additional feedback from a User Equipment (UE) associated with the at least one QoS flow, wherein the feedback transmitted to the other network node comprises the additional feedback from the UE.

Example Embodiment E16. The method of any one of Example Embodiments E14 to E15, wherein transmitting the feedback comprises: transmitting the feedback from a distributed unit of the network node to a centralized unit of the network node; and transmitting the feedback from the centralized unit of the network node to the other network node.

Example Embodiment E17. The method of any one of Example Embodiments E14 to E16, wherein the feedback comprises a request for additional assistance information and/or a third set of TSCAI parameters.

Example Embodiment E18. The method of Example Embodiment E17, comprising determining to transmit the request for the additional assistance information and/or the third set of TSCAI parameters based on at least one of: at least one available radio resource; an amount of network congestion and/or load; an amount of data to be received and/or transmitted by the network node; and an amount of data to be received and/or transmitted by a plurality of user equipments (UEs) served by the network node.

Example Embodiment E19. The method of any one of Example Embodiment E1 to E18, comprising: transmitting, to the other network node, capability information indicating at least one TSCAI parameter and/or range of TSCAI parameters that the network node is able to use.

Example Embodiment E20. The method of Example Embodiment E19, wherein: the at least one TSCAI parameter and/or range of TSCAI parameters indicated in the capability information is a same as or overlaps with at least one TSCAI parameter in the second set of TSCAI parameters; and the at least one TSCAI parameter and/or range of TSCAI parameters indicated in the capability information is a same as or overlaps with at least one TSCAI parameter in the first set of TSCAI parameters after the first set of TSCAI parameters is adjusted based on the assistance information.

Example Embodiment E21. The method of any one of Example Embodiments E19 to E20, comprising: receiving, from the other network node, a request for the capability information.

Example Embodiment E22. The method of any one of Example Embodiments E19 to E21, wherein the at least one TSCAI parameter and/or range of TSCAI parameters indicated in the capability information comprises at least one of: at least one value and/or range of values associated with a flow direction; at least one value and/or range of values associated with a periodicity; at least one value and/or range of values associated with a burst arrival time; and at least one value and/or range of values associated with a survival time.

Example Embodiment E23. The method of any one of Example Embodiments E1 to E22, comprising: transmitting, to the other network node, an offset to be applied to at least one TSCAI parameter in the first set of TSCAI parameters.

Example Embodiment E24. The method of Example Embodiment E22, comprising: receiving, from the other network node, a request for the offset.

Example Embodiment E25. The method of any one of Example Embodiments E1 to E24, comprising: transmitting, to the other network node, a request for the assistance information and/or the second set of TSCAI parameters.

Example Embodiment E26. The method of Example Embodiment E25, comprising determining to transmit the request for the assistance information and/or the second set of TSCAI parameters based on at least one of: at least one available radio resource; an amount of network congestion and/or load; an amount of data to be received and/or transmitted by the network node; and an amount of data to be received and/or transmitted by a plurality of user equipments (UEs) served by the network node.

Example Embodiment E27. The method of any one of Example Embodiments E1 to E26, comprising: receiving, from the other network node, information indicating that at least one of the first set of TSCAI parameters and the second set of TSCAI parameters may not be modified or negotiated by the network node.

Example Embodiment E28. The method of any one of Example Embodiments E1 to E27, wherein the first set of TSCAI parameters and/or the second set of TSCAI parameters comprises: at least one value for an associated TSCAI parameter; and/or information for determining a range of values for an associated TSCAI parameter.

Example Embodiment E29. The method of any one of Example Embodiments E1 to E28, wherein the network node comprises a gNodeB (gNB).

Example Embodiment E30. The method of any one of Example Embodiments E1 to E29, wherein the other network node comprises a core network (CN) node and/or is associated with a CN.

Example Embodiment E31. The method of any one of Example Embodiments E1 to E30, further comprising: obtaining user data; and forwarding the user data to a host or a user equipment.

Example Embodiment E32. A network node comprising processing circuitry configured to perform any of the methods of Example Embodiments E1 to E31.

Example Embodiment E33. A network node configured to perform any of the methods of Example Embodiments E1 to E31.

Example Embodiment E34. A computer program comprising instructions which when executed on a computer perform any of the methods of Example Embodiments E1 to E31.

Example Embodiment E35. A computer program product comprising computer program, the computer program comprising instructions which when executed on a computer perform any of the methods of Example Embodiments E1 to E31.

Example Embodiment E36. A non-transitory computer readable medium storing instructions which when executed by a computer perform any of the methods of Example Embodiments E1 to E31.

### Group F Example Embodiments

Example Embodiment F1. A user equipment for negotiating parameters associated with a time sensitive communication (TSC), the UE comprising: processing circuitry configured to perform any of the steps of any of the Group A and C Example Embodiments; and power supply circuitry configured to supply power to the processing circuitry.

Example Embodiment F2. A network node for negotiating parameters associated with a time sensitive communication (TSC), the network node comprising: processing circuitry configured to perform any of the steps of any of the Group B, D, and E Example Embodiments; power supply circuitry configured to supply power to the processing circuitry.

Example Embodiment F3. A user equipment (UE) for negotiating parameters associated with a time sensitive communication (TSC), the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment F4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment F5. The host of the previous Example Embodiment, wherein the cellular network further includes a network node configured to communicate with the UE to transmit the user data to the UE from the host.

Example Embodiment F6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment F8. The method of the previous Example Embodiment, further comprising: at the host, executing a host application associated with a client application executing on the UE to receive the user data from the UE.

Example Embodiment F9. The method of the previous Example Embodiment, further comprising: at the host, transmitting input data to the client application executing on the UE, the input data being provided by executing the host application, wherein the user data is provided by the client application in response to the input data from the host application.

Example Embodiment F10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment F11. The host of the previous Example Embodiment, wherein the cellular network further includes a network node configured to communicate with the UE to transmit the user data from the UE to the host.

Example Embodiment F12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment F14. The method of the previous Example Embodiment, further comprising: at the host, executing a host application associated with a client application executing on the UE to receive the user data from the UE.

Example Embodiment F15. The method of the previous Example Embodiment, further comprising: at the host, transmitting input data to the client application executing on the UE, the input data being provided by executing the host application, wherein the user data is provided by the client application in response to the input data from the host application.

Example Embodiment F16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B, D, and E Example Embodiments to transmit the user data from the host to the UE.

Example Embodiment F17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment F18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B, D, and E Example Embodiments to transmit the user data from the host to the UE.

Example Embodiment F19. The method of the previous Example Embodiment, further comprising, at the network node, transmitting the user data provided by the host for the UE.

Example Embodiment F20. The method of any of the previous 2 Example Embodiments, wherein the user data is provided at the host by executing a host application that interacts with a client application executing on the UE, the client application being associated with the host application.

Example Embodiment F21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B, D, and E Example Embodiments to transmit the user data from the host to the UE.

Example Embodiment F22. The communication system of the previous Example Embodiment, further comprising: the network node; and/or the user equipment.

Example Embodiment F23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B, D, and E Example Embodiments to receive the user data from a user equipment (UE) for the host.

Example Embodiment F24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment F25. The host of the any of the previous 2 Example Embodiments, wherein the initiating receipt of the user data comprises requesting the user data.

Example Embodiment F26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B, D, and E Example Embodiments to receive the user data from the UE for the host.

Example Embodiment F27. The method of the previous Example Embodiment, further comprising at the network node, transmitting the received user data to the host.

1. A method by a user equipment, UE, for negotiating parameters associated with a time sensitive communication, TSC, the method comprising:
receiving, from a Radio Access Network, RAN, node, a first set of TSC assistance information, TSCAI, parameters and an indication to provide feedback; and
transmitting, to the RAN node, feedback associated with a used set of TSCAI parameters and/or a second set of TSCAI parameters.

2. The method of claim 1, comprising receiving, from the RAN node, the second set of TSCAI parameters.

3. The method of claim 1, wherein the second set of TSCAI parameters comprises at least one parameter that is different from at least one parameter in the first set of TSCAI parameters.

4. The method of claim 1, wherein at least one of the first set of TSCAI parameters and the second set of TSAI parameters comprise at least one of:
at least one value and/or range of values associated with a flow direction;
at least one value and/or range of values associated with a periodicity;
at least one value and/or range of values associated with a burst arrival time; and
at least one value and/or range of values associated with a survival time.

5. The method of claim 1, comprising at least one of:
using the first set of TSCAI parameters for at least one Quality of Service, QoS, flow;
using an adjusted set of TSCAI parameters for at least one QoS flow, wherein the adjusted set of TSACI parameters is obtained by adjusting the first set of TSCAI parameters based on assistance information received from the RAN node; and
using the second set of TSCAI parameters for at least one QoS flow.

6. The method of claim 5, wherein using the first set of TSCAI parameters, the adjusted set of TSCAI parameters or the second set of TSCAI parameters comprises transmitting or receiving a signal using an accepted parameter from the first set of TSCAI parameters, the adjusted set of TSCAI parameters or the second set of TSCAI parameters, respectively.

7. The method of claim 5, comprising selecting one of the first set of TSCAI parameters, the adjusted set of TSCAI parameters, and/or the second set of TSCAI parameters to use for the at least one QoS flow.

8. The method of claim 7, wherein selecting the one of the first set of TSCAI parameters, the adjusted set of TSCAI parameters, and/or the second set of TSCAI parameters comprises selecting a best one of the first set of TSCAI parameters, the adjusted set of TSCAI parameters, and/or the second set of TSCAI parameters based on at least one of:
at least one available radio resource;
an amount of network congestion and/or load; and
an amount of data to be received from and/or transmitted to the at least one network node.

9. The method of claim 1, wherein the feedback indicates at least one of:
the UE used the first set of TSCAI parameters for at least one QoS flow;
the UE used an adjusted set of TSCAI parameters for at least one QoS flow; and
the UE used the second set of TSCAI parameters for at least one QoS flow.

10. The method of claim 9, comprising
receiving a request for the feedback from the RAN node, and
wherein the feedback is transmitted to the RAN node based on the request and/or indication.

11. The method of claim 1, comprising determining to transmit a request for additional assistance information and/or a third set of TSCAI parameters based on at least one of:
at least one available radio resource;
an amount of network congestion and/or load; and
an amount of data to be received from and/or transmitted to the RAN node.

12. The method of claim 1, comprising:
transmitting, to the RAN node, capability information indicating at least one TSCAI parameter and/or range of TSCAI parameters that the UE is able to use.

13. The method of claim 1, comprising:
transmitting, to the RAN node, an offset to be applied to at least one TSCAI parameter in the first set of TSCAI parameters.

14. The method of claim 1, comprising:
receiving, from the RAN node, information indicating that at least one of the first set of TSCAI parameters and the second set of TSCAI parameters may not be modified or negotiated by the UE.

15. The method of claim 1, wherein the feedback is transmitted to a core network, CN, node via the RAN node.

16. A method by a core network, CN, node for negotiating parameters associated with a time sensitive communication, TSC, the method comprising:
transmitting, to a Radio Access Network, RAN, node, a first set of TSC assistance information, TSCAI, parameters; and
receiving, from the RAN node, feedback associated with a used set of TSCAI parameters and/or a second set of TSCAI parameters.

17. The method of claim 16, comprising transmitting to the RAN node the second set of TSCAI parameters.

18. The method of claim 16, wherein the second set of TSCAI parameters comprises at least one parameter that is different from at least one parameter in the first set of TSCAI parameters.

19. The method of claim 16, wherein at least one of the first set of TSCAI parameters and the second set of TSAI parameters comprise at least one of:
at least one value and/or range of values associated with a flow direction;
at least one value and/or range of values associated with a periodicity;
at least one value and/or range of values associated with a burst arrival time; and
at least one value and/or range of values associated with a survival time.

20. The method of claim 16, wherein the feedback indicates at least one of:
the RAN node and/or a UE used the first set of TSCAI parameters for at least one Quality of Service, QoS, flow;
the RAN node and/or the UE used an adjusted set of TSCAI parameters for at least one QoS flow, wherein the adjusted set of TSACI parameters is obtained by adjusting the first set of TSCAI parameters based on assistance information; and
the other network node used the second set of TSCAI parameters for at least one QoS flow.

21. The method of claim 20, comprising transmitting the feedback from the RAN node to a service application level.

22. The method of claim 20, wherein the feedback is from the UE associated with the at least one QoS flow.

23.-25. (canceled)

26. A method by a Radio Access Network, RAN, node for negotiating parameters associated with a time sensitive communication, TSC, the method comprising:
receiving, from a core network, CN, node, a first set of TSCAI parameters; and
transmitting, to the CN, feedback associated with a used set of TSCAI parameters and/or a second set of TSCAI parameters.

27.-40. (canceled)

41. A user equipment, UE, for negotiating parameters associated with a time sensitive communication, TSC, the UE being configured to:
receive, from a Radio Access Network, RAN, node, a first set of TSC assistance information, TSCAI, parameters and an indication to provide feedback; and
transmit, to the RAN node, feedback associated with at least one used TSCAI parameter and/or a second set of TSCAI parameters.

42.-46. (canceled)
